(19) United States
(12) Patent Application Publication
(10) Pub. No.: US 2003/0126108 A1
(43) Pub. Date: Jul. 3, 2003

(54) Method and apparatus for access and display of content allowing users to apply multiple profiles

(75) Inventors: Jacquelyn Martino, Cold Spring, NY (US); John Zimmerman, Ossining, NY (US)

Correspondence Address: PHILIPS ELECTRONICS NORTH AMERICAN CORP, 580 WHITE PLAINS RD, TARRYTOWN, NY, 10591, US

(73) Assignee: KNOINKLIJKE PHILIPS ELECTRONICS N.V., Eindhoven (NL)

(21) Appl. No.: 10/037,464

(22) Filed: Dec. 31, 2001

(51) Int. Cl. G06F 7/00

(52) U.S. Cl. 707/1

(57) ABSTRACT

Multiple individual profiles may be concurrently selected and applied in combination to a search system, forming an ad hoc profile enabling quick identification of content of high recommendation to all whose profiles are selected. Such ad hoc combination profiles are especially advantageous for forming dynamic group profiles which automatically track changes to individual member profiles and which are easily adapted by addition or deletion of a member, and may be used in conjunction with portable profiles communicated between systems. A variety of combination techniques may be employed for merging the multiple profiles, from simple averaging of rating values to more complex models allowing variable weighting or selective applicability of user profiles or the search attribute values therein.

### CROSS-REFERENCE TO RELATED APPLICATIONS

The present invention is related to those disclosed in the following U.S. Non-Provisional patent applications:

1) [Docket No. US010683] filed concurrently herewith, entitled “METHOD OF POPULATING AN EXPLICIT PROFILE”;

2) [Docket No. US010685] filed concurrently herewith, entitled “SORT SLIDER WITH CONTEXT INTUITIVE SORT KEYS”;

3) [Docket No. US010686] filed concurrently herewith, entitled “VISUALIZATION OF ENTERTAINMENT CONTENT.”

The above applications are commonly assigned to the assignee of the present invention. The disclosures of these related patent applications are hereby incorporated by reference for all purposes as if fully set forth herein.

### TECHNICAL FIELD OF THE INVENTION

The present invention is directed, in general, to search systems and, more specifically, to search systems providing suggestions based on particularized user profiles.

### BACKGROUND OF THE INVENTION

Various “recommenders,” utilities suggesting items to a user based on the user's likes and dislikes, are employed for suggesting television programming, music, books or other items. In suggesting items, such recommenders may employ a specific user's profile, user-independent data regarding relatedness of items, or both. For entertainment content such as video programming, music, books and games, suggestions more likely to match a user's tastes may be provided by recommenders if generated employing, at least in part, an explicit user profile of likes and/or dislikes.

Most current recommender systems either separately utilize individual profiles or utilize a single aggregate profile without capability to differentiate between individual users. Systems which utilize individual profiles may provide or enable a “Family” or other fixed group profile, but such fixed group profiles are discrete and must be manually updated together with individual profiles. Moreover, fixed group profiles do not provide sufficient fluidity to accommodate the specific, short-term groupings possible utilizing portable profiles.

There is, therefore, a need in the art for a system of using multiple profiles in combination while providing flexibility in forming an updating profile combinations.

### SUMMARY OF THE INVENTION

To address the above-discussed deficiencies of the prior art, it is a primary object of the present invention to provide, for use in a search system, a technique for allowing multiple individual profiles to be concurrently selected and applied in combination to a search system, forming an ad hoc profile enabling quick identification of content of high recommendation to all whose profiles are selected. Such ad hoc combination profiles are especially advantageous for forming dynamic group profiles which automatically track changes to individual member profiles and which are easily adapted by addition or deletion of a member, and may be used in conjunction with portable profiles communicated between systems. A variety of combination techniques may be employed for merging the multiple profiles, from simple averaging of rating values to more complex models allowing variable weighting or selective applicability of user profiles or the search attribute values therein.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a content reception system employing a recommender search system capable of employing two or more profiles in combination according to one embodiment of the present invention;

FIG. 2 is a mockup of a user interface display for a content reception system controller employing a recommender search system capable of employing two or more profiles in combination according to one embodiment of the present invention; and

FIG. 3 is a high level flowchart for a process of selectively employing two or more profiles in combination during a search according to one embodiment of the present invention.

### DETAILED DESCRIPTION OF THE INVENTION

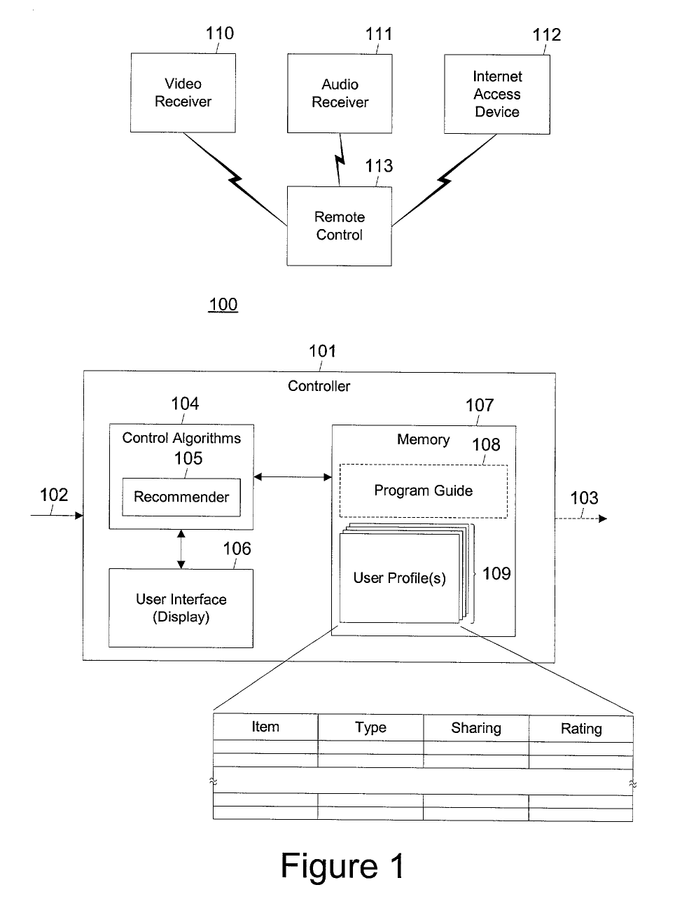

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device.

FIG. 1 depicts a content reception system employing a recommender search system capable of employing two or more profiles in combination according to one embodiment of the present invention. Within a content reception system 100, a controller 101 receives at least information regarding content available from one or more external sources (not shown) such as a broadcasting facility or a broadcast or Internet content server, as well as optionally the associated content. Accordingly, controller 101 may be implemented within a video receiver 110 such as a television, a satellite, terrestrial, or cable television broadcast decoder unit, or a digital video recorder, within an audio receiver 111 such as a terrestrial or satellite radio receiver or a compact disc or digital audio player, or within an Internet access device 112 such as a set-top box, a personal computer or the like. Additionally, controller 101 may be implemented within a remote control device 113 adapted for controlling the operation of one or more of the video receiver 110, the audio receiver 111, and the Internet access device 112, and optionally including an integral display and the like. Controller 101 may also be implemented in a distributed fashion, with various portions being disposed within two or more devices forming the video receiver 110, the audio receiver 111, the Internet access device 112, and the remote control 113.

However implemented, content reception system controller 101 includes an input 102 for receiving at least the information regarding content available from the one or more external sources and optionally an output 103 for transmitting content, control signals, and/or user interface data to a receiver, display or recording device.

Those skilled in the art will recognize that the full construction and operation of a content reception system controller is not depicted or described herein. Instead, for simplicity and clarity, only so much of the construction and operation of a content reception system controller as is unique to the present invention or necessary for and understanding of the present invention is depicted and described. The remainder of the construction and operation of the controller may follow conventional practices known in the art. Moreover, although a video receiver, an audio receiver, an Internet access device, and a remote control are employed in the exemplary embodiment, those skilled in the art will recognize that the functionality described herein may be readily adapted to other types of devices such as, for example, game devices, and thereby employed with other forms of content.

In the exemplary embodiment, content reception system controller 101 includes a control algorithms or programmable logic circuits 104 including a recommender search module or functionality 105. A user interface 106 communicably coupled to the controller 104 enables user input from, for example, an infrared remote control, a touch screen, or input buttons. User interface 106 may include a display or, alternatively, controller 101 may be coupled to a separate display device. Controller 101 in the exemplary embodiment also includes a memory 107, preferably nonvolatile. Memory 107 is employed to optionally store information 108 about available content (e.g., a program guide) and to store one or more user profiles 109. User profiles 109 in the example shown are explicit profiles of user preferences having, associated with each item, an item type and a user rating value for the respective item, although other types of profiles such as collected historical viewing information may be employed. Recommender 105 and user profiles 109 may, of course, be located on a remote system from controller 101 and transmit suggestions to controller 101.

In the present invention, rather than limiting recommender 105 to only a single profile at a time, recommender 105 is capable of selectively employing multiple individual profiles concurrently as described in further detail below.

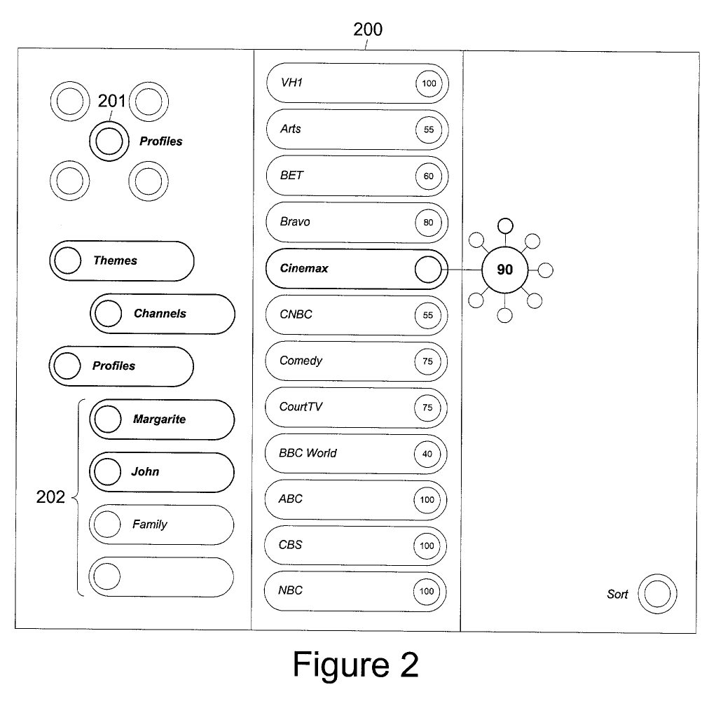

FIG. 2 is a mockup of a user interface display for a content reception system controller employing a recommender search system capable of employing two or more profiles in combination according to one embodiment of the present invention. The user interface depicted is employed, for example, by controller 101 depicted in FIG. 1. User interface display 200 includes a user control 201 for enabling selection of a user profile to be employed in performing content searches. When user control 201 is actuated, a listing 202 of defined user profiles is displayed within user interface display 200. Each item within listing 202 is itself a user control allowing the respective item to be selected or deselected as an active profile. Selected items are highlighted or otherwise varied in appearance from nonselected items.

In the present invention, multiple items within listing 202 may be concurrently selected, thereby selecting multiple user profiles in combination as the active profile. In the example shown, users “Margarite” and “John” each have their own profiles for television viewing and may not often watch television together. Should they decide to watch television together, however, they may employ both of their individual profiles together for application to a search request, and expect that the results will suit them both.

In employing multiple profiles for a search, the user profiles may be combined in a variety of manners. A simple averaging of numerical ratings, if any, specified by each user in ranking program attributes (e.g., category such as sports, comedy, drama, etc., program title, actor(s) and/or director(s), channel, and the like) may be employed. Alternatively, each user profile may be applied separately to discrete searches and a union or intersection in the search results sought. Other, more complex models may be utilized to take into account parental viewing guidelines for violent or sexually-oriented content within one or more the selected profiles, to define heuristics for addressing conflicts between two or more profiles, to allow one of the profiles or some of the attributes to be given more weight or importance than the other(s) within the aggregate or combined profile, or to ignore or selectively apply certain attributes within one or all of the selected profiles (for instance, using only the ranking of figure skating at negative infinity from one user profile while using all attribute rankings from a second user profile).

The combination of two or more individual user profiles in the present invention effectively creates an ad hoc additional profile. An ongoing group profile (e.g., “Family”) may be defined by specifying the individual profiles to be combined to form that group profile, together with any particular variations unique to the combination such as the varying weights described above. Since the group profile is defined by specifying individual profiles rather than a completely separate profile, the group profile is dynamic and automatically reflects changes to a member individual profile, and may be more quickly modified to add or delete a particular individual member profile.

The ad hoc nature of combined profiles is especially advantageous with systems supporting portable profiles, which may be transferred from system to system, allowing an impromptu group of people to quickly find content of high recommendation to all in the group. Thus, for example, a gaggle of teenagers having a spur-of-the-moment pizza party may quickly formulate a group profile by retrieving and selecting all of their respective individual profiles.

Users may also specify which portions of their profiles are “private” and which portions may be shared with other user, and/or designate specific elements within the profile for sharing with specific users. Thus, for example, a user may specify one portion or set of elements from their profile for sharing with their children, another portion or set of elements for sharing with their spouse and children, and a third portion or set of elements for sharing with their spouse alone, while reserving a remainder of the profile from any sharing with any other user. Sharing with other users, either generally or with specific users, may be specified either globally for the entire profile or by individual profile element, or globally for some other users but by individual profile element for others.

Both explicit portions of a user profile (created by manual entry of ratings by the user) and implicit portions (derived from the user's content consumption or viewing history) may be combined with other user profiles. However, since implicit profiles or individual viewing histories are difficult to track since viewers dislike identifying themselves to a television, and automatic identification techniques such as cameras or fingerprint sensors are expensive, individual explicit profiles may be combined with implicit group or family profiles. Sharing restrictions designating public, limited access and private portions of a user profile for combination purposes may apply to either explicit or implicit profiles.

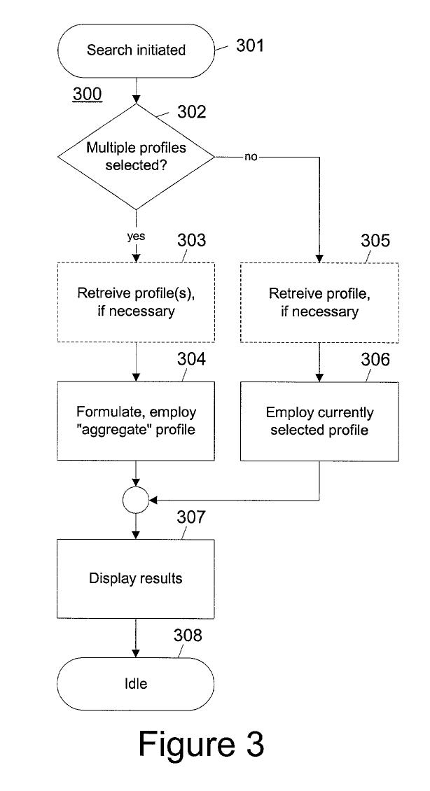

FIG. 3 is a high level flowchart for a process of selectively employing two or more profiles in combination during a search according to one embodiment of the present invention. The process 300 begins with a search involving user profiles being initiated (step 301). A determination is made of whether multiple user profiles are selected as active (step 302). If so, one or more required user profiles may be retrieved, if necessary (step 303), and an “aggregate” profile is formulated and employed in conducting the requested search (step 304), or the profiles are otherwise used in conjunction with each other as described above. This portion of the process (steps 303-304) is also employed for single, group profiles which are defined as a combination of individual user profiles rather than as a direct set of ratings or the like.

If only a single user profile is active or selected when the search is initiated, the profile is retrieved, if necessary (step 305) and employed to conduct the requested search (step 306). The results are then displayed to the user (step 307) and the process becomes idle (step 308) until another search involving user profiles is initiated.

The present invention allows multiple user profiles to be utilized in combination in conducting a search for content, producing search results more likely to be acceptable to all users whose profiles are included. Group profiles may be defined as combinations of individual profiles with special variations, and thereby dynamically follow updates to the individual profiles. By facilitating ad hoc formation of profiles from other profiles, the present invention finds advantage in use with portable profiles.

It is important to note that while the present invention has been described in the context of a fully functional system, those skilled in the art will appreciate that at least portions of the mechanism of the present invention are capable of being distributed in the form of a machine usable medium containing instructions in a variety of forms, and that the present invention applies equally regardless of the particular type of signal bearing medium utilized to actually carry out the distribution. Examples of machine usable mediums include: nonvolatile, hard-coded type mediums such as read only memories (ROMs) or erasable, electrically programmable read only memories (EEPROMs), recordable type mediums such as floppy disks, hard disk drives and compact disc read only memories (CD-ROMs) or digital versatile discs (DVDs), and transmission type mediums such as digital and analog communication links.

Although the present invention has been described in detail, those skilled in the art will understand that various changes, substitutions, variations, enhancements, nuances, gradations, lesser forms, alterations, revisions, improvements and knock-offs of the invention disclosed herein may be made without departing from the spirit and scope of the invention in its broadest form.

What is claimed is:

1. A search system comprising:
a plurality of user profiles each defining preferences of a respective individual user or group of users; and
a recommender adapted to selectively employ two or more of the plurality of user profiles in combination when searching for content suggestions.

2. The search system according to claim 1, wherein the recommender employs the two or more user profiles in combination by averaging ratings for each rated attribute within the two or more individual user profiles.

3. The search system according to claim 1, wherein the recommender employs the two or more user profiles in combination by:
applying limits within only one of the two or more user profiles when searching for content suggestions;
weighting ratings for each rated attribute within one of the two or more user profiles greater than corresponding ratings within remaining user profiles from the two or more user profiles; or
weighting ratings for selected rated attributes within each of the two or more user profiles greater than ratings for remaining rated attributes within each of the two or more user profiles.

4. The search system according to claim 1, wherein the recommender is adapted to selectively employ group profiles defined as a combination of two or more of the plurality of user profiles by employing the two or more user profiles in combination when searching for content suggestions.

5. The search system according to claim 1, wherein at least one of the two or more user profiles employed in combination when searching for content suggestions is retrieved from another system.

6. The search system according to claim 1, wherein the two or more user profiles may be either explicit or implicit profiles.

7. The search system according to claim 1, wherein one of the user profiles is a profile for a group of users.

8. The search system according to claim 1, wherein one of the user profiles includes at least first and second portions, each of the first and second portions designated as publicly available for combination with any other user profile, restricted to combination only with specified user profiles, or restricted from combination with any other user profile.

9. A video receiver comprising:
an input for receiving content and a plurality of information items regarding the content;
a plurality of individual user profiles each defining preferences of a respective individual user; and
a recommender adapted to selectively employ two or more of the plurality of individual user profiles in combination when evaluating the information items to generate content suggestions.

10. The video receiver according to claim 9, wherein the recommender employs the two or more individual user profiles in combination by averaging ratings for each rated attribute within the two or more individual user profiles.

11. The video receiver according to claim 9, wherein the recommender employs the two or more individual user profiles in combination by:
applying limits within only one of the two or more individual user profiles when searching for content suggestions;
weighting ratings for each rated attribute within one of the two or more individual user profiles greater than corresponding ratings within remaining individual user profiles from the two or more individual user profiles; or
weighting ratings for selected rated attributes within each of the two or more individual user profiles greater than ratings for remaining rated attributes within each of the two or more individual user profiles.

12. The video receiver according to claim 9, wherein the recommender is adapted to selectively employ group profiles defined as a combination of two or more of the plurality of individual user profiles by employing the two or more individual user profiles in combination when evaluating the information items to generate content suggestions.

13. The video receiver according to claim 9, wherein at least one of the two or more individual user profiles employed in combination when evaluating the information items to generate content suggestions is retrieved from another system.

14. A method of processing information items comprising:
receiving content and a plurality of information items regarding the content;
accessing a plurality of individual user profiles each defining preferences of a respective individual user; and
selectively employing two or more of the plurality of individual user profiles in combination when evaluating the information items to generate content suggestions.

15. The method according to claim 14, wherein the two or more individual user profiles are employed in combination by averaging ratings for each rated attribute within the two or more individual user profiles.

16. The method according to claim 14, wherein the two or more individual user profiles are employed in combination by:
applying limits within only one of the two or more individual user profiles when searching for content suggestions;
weighting ratings for each rated attribute within one of the two or more individual user profiles greater than corresponding ratings within remaining individual user profiles from the two or more individual user profiles; or
weighting ratings for selected rated attributes within each of the two or more individual user profiles greater than ratings for remaining rated attributes within each of the two or more individual user profiles.

17. The method according to claim 14, further comprising:
selectively employing group profiles defined as a combination of two or more of the plurality of individual user profiles by employing the two or more individual user profiles in combination when evaluating the information items to generate content suggestions.

18. The method according to claim 14, further comprising:
retrieving at least one of the two or more individual user profiles employed in combination when evaluating the information items to generate content suggestions from another system.

19. A signal comprising:
a listing of content suggestions relating to content and a plurality of information items regarding the content,
wherein two or more of a plurality of individual user profiles each defining preferences of a respective individual user are selectively employed in combination when evaluating the information items to generate the listing of content suggestions.

20. The signal according to claim 19, wherein the two or more individual user profiles are employed in combination by averaging ratings for each rated attribute within the two or more individual user profiles.

21. The signal according to claim 19, wherein the two or more individual user profiles are employed in combination by:
applying limits within only one of the two or more individual user profiles when searching for content suggestions;
weighting ratings for each rated attribute within one of the two or more individual user profiles greater than corresponding ratings within remaining individual user profiles from the two or more individual user profiles; or
weighting ratings for selected rated attributes within each of the two or more individual user profiles greater than ratings for remaining rated attributes within each of the two or more individual user profiles.

22. The signal according to claim 19, wherein group profiles defined as two or more of the plurality of individual user profiles employed in combination are utilized when evaluating the information items to generate the listing of content suggestions.

23. The signal according to claim 19, wherein at least one of the two or more individual user profiles employed in combination when evaluating the information items to generate content suggestions is retrieved from a remote system.
